(19) United States
(12) Patent Application Publication
(10) Pub. No.: US 2023/0344926 A1
(43) Pub. Date: Oct. 26, 2023

(54) ADJUSTABLE HANDS-FREE ELECTRONIC DEVICE HOLDING SYSTEM

(71) Applicant: Bridget Thaniel, Deltona, FL (US)

(72) Inventor: Bridget Thaniel, Deltona, FL (US)

(21) Appl. No.: 18/139,127

(22) Filed: Apr. 25, 2023

Related U.S. Application Data
(60) Provisional application No. 63/335,154, filed on Apr. 26, 2022.

(51) Int. Cl. H04M 1/04; F16M 11/12; F16M 11/18; F16M 13/02

(52) U.S. Cl. CPC H04M 1/04; F16M 11/12; F16M 11/18; F16M 13/02

(57) ABSTRACT

An adjustable hands-free electronic device holding system includes a spring-loaded mounting clamp having a pair of clamp arms that function to engage a secondary object. An elongated flexible shaft is positioned between one of the clamp arms and a device cradle. The device cradle includes a main body section and a pair of arms for engaging and securing a portable electronic device to the cradle. The flexible elongated shaft includes a telescoping section having a fixed tube, an expanding rod and a tensioning ring. The telescoping section allows the length of the shaft and the distance between the clamp and cradle to be selectively increased or decreased. A rechargeable battery pack is secured along the clamp and supplies power to the portable electronic device stored within the cradle.

### CROSS-REFERENCE TO RELATED APPLICATIONS

This application claims the benefit of U.S. Application Ser. No. 63/335,154 filed on Apr. 26, 2022, the contents of which are incorporated herein by reference.

### TECHNICAL FIELD

The present invention relates generally to smartphone accessories, and more particularly to an adjustable hands-free electronic device holder.

### BACKGROUND

The statements in this section merely provide background information related to the present disclosure and may not constitute prior art.

Due to our increasing reliance on personal electronic devices such as smartphones and tablet computers, for example, it is relatively common for people to use these devices when lying in a bed or other piece of furniture.

When lying horizontally, a user must physically lift and suspend the electronic device at a raised position for prolonged periods of time. Although this is easy for short intervals of a few seconds to a few minutes, the longer the device is supported the heavier it feels. As such, it can be difficult for a user to comfortably hold the device at a raised position for optimum viewing for long periods of time as would be required when surfing the net or watching videos, for example.

Accordingly, it would be beneficial to provide an adjustable hands-free electronic device holding system that can be secured onto a bed or other such structure and that can be adjustable by a user to position the device at any number of viewing positions. It would also be beneficial if the device could be portable in nature so as to be capable of being secured onto other objects such as tables, car seats and the like.

### SUMMARY OF THE INVENTION

The present invention is directed to an adjustable hands-free electronic device holding system. One embodiment of the present invention can include a spring-loaded mounting clamp having a pair of clamp arms that function to engage a secondary object. An elongated flexible shaft can be positioned between one of the clamp arms and a device cradle. The device cradle can include a main body section for receiving a portable electronic device, and a pair of arms that can expand and contract to secure the portable electronic device to the cradle.

In one embodiment, the flexible elongated shaft can include a telescoping section having a fixed tube, an expanding rod, and a tensioning ring. The telescoping section can function to allow the length of the shaft and the distance between the clamp and cradle to be selectively increased or decreased.

In one embodiment, a rechargeable battery pack can be secured along or within the clamp. The battery pack can function to supply power to the portable electronic device stored within the cradle.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of an adjustable hands-free electronic device holding system, in accordance with one embodiment of the invention.

FIG. 2 is a side view of the elongated shaft of the adjustable hands-free electronic device holding system, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described herein, the term “connector” includes any number of different elements that work alone or together to repeatedly join two items together in a nonpermanent manner. Several nonlimiting examples of connectors include, but are not limited to, flexible strips of interlocking projections with a slider (i.e., zipper), thread-to-connect, twist-to-connect, and push-to-connect type devices, opposing strips of hook and loop material (e.g., Velcro®), attractively oriented magnetic elements or magnetic and metallic elements, buckles such as side release buckles, clamps, sockets, clips, carabiners, and compression fittings such as T-handle rubber draw latches, hooks, snaps and buttons, for example.

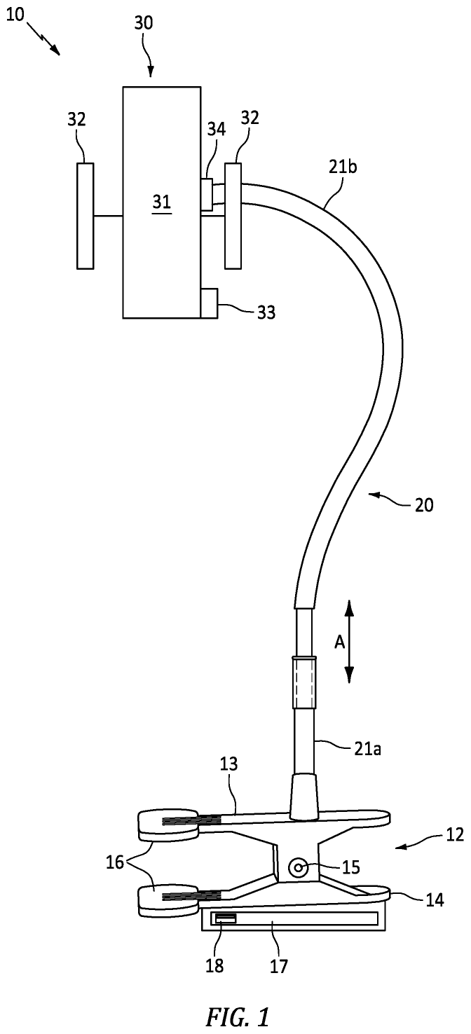

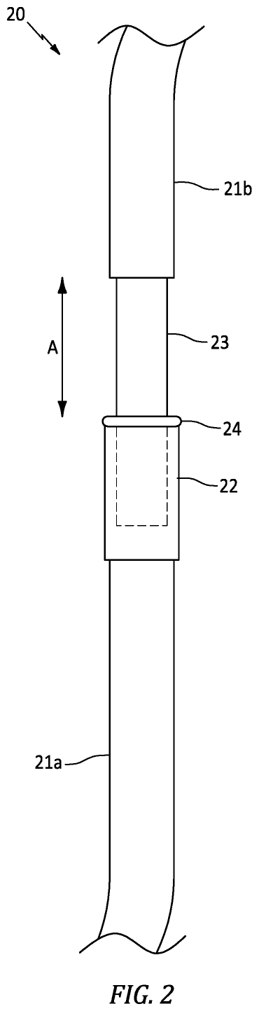

FIGS. 1 and 2 illustrate one embodiment of an adjustable hands-free electronic device holding system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof relate to the invention as oriented in FIG. 1.

As shown best at FIG. 1, one embodiment of the system can include, essentially, a mounting clamp 12, a flexible shaft 20, and a cradle 30.

The mounting clamp 12 can function to secure the system onto any number of secondary objects in order to utilize the system in the manner hereinafter described. In one embodiment, the mounting clamp can include a pair of clamping arms 13 and 14 that are joined together by a centralized resilient spring 15. In various embodiments, the inside surfaces of the clamping arms can include foam or padding 16 to prevent the clamp from scratching an object to which it is secured.

In one embodiment, a rechargeable battery pack 17 can be positioned within or along the clamp 12. The battery can include a charging port 18 for receiving a cable that can connect to an electronic device that is positioned with the below described cradle. Such a feature advantageously allows a user to charge their device when using the system at locations within a home or office where a power outlet is not available, and/or at remote locations such as the beach, for example.

As described herein, the mounting clip may be formed from materials that are, for example, relatively strong and stiff for their weight. Several nonlimiting examples include but are not limited to various metals or metal alloys, plastic/polymers (e.g., high-density polyethylene (HDPE), rigid polyvinyl chloride (PVC), or polyethylene terephthalate (PET)), and/or various composite materials. Of course, the mounting clip is not limited to the alligator-style clamp shown, as any number of other types of connectors capable of securing the system onto any type of secondary object such as a headboard, tabletop, beach chair, car seat and the like are also contemplated.

The flexible shaft 20 can include an elongated malleable shaft body having a lower section 21a that is connected to one of the clamping arms 13, and an upper section 21b that is connected to the main body of the cradle 30. The shaft can include any number of different lengths and can preferably be constructed from a material which allows flexion in three dimensions in order to allow a user to orient the cradle at any number of different positions. As described herein, the shaft may be constructed from any number of different materials such as various soft metals or alloys, rubber, and/or flexible plastics, for example.

As shown best at FIG. 2, one embodiment of the shaft can be telescopic in nature for allowing a user to increase or decrease the distance between the clamp and cradle. To this end, the shaft can include a fixed hollow tube 22, and a sliding bar 23 that extends from and retracts into one end of the fixed hollow tube (see arrow A). A tension ring 24 can be provided along the end of the fixed tube section and can act to secure the sliding bar section at a user defined length.

Although shown as being connected to the respective portions of the shaft along distal ends, this is for illustrative purposes only, as other embodiments are contemplated wherein the telescoping components 22 and 23 are positioned within the upper and lower tube sections 21b and 21a, respectively. Such a feature provides a more aesthetically pleasing design and functioning to protect the delicate telescoping components during operation.

The cradle 30 can be pivotally secured to the upper section of shaft 21b and can include a central body section 31 for receiving an electronic device, and a pair of adjustable arms 32 which are mechanically linked together. The arms can include an internal spring and ratchet system that permits the arms to move laterally from and toward the central member upon actuation of a button 33. One embodiment of a suitable cradle for use herein is described in U.S. Pat. No. 6,285,758, to Lu, the contents of which are incorporated herein by reference.

In the preferred embodiment, a knuckle joint 34, can secure the upper section of the shaft 21b to the back surface of the central member 31, so as to allow the cradle to rotate in three dimensions relative to the shaft. Of course, any number of other connectors capable of joining the shaft and cradle together are also contemplated.

In operation, a user can secure the clamp 15 onto any secondary object such as a headboard or beach chair for example via the clamp arms and can further secure an electronic device such as a smartphone or tablet computer into the cradle 30. If desired, the user can plug a charging cable into the jack 19a of the rechargeable battery pack 19 to provide power to the device and can adjust the length and orientation of the shaft to orient the device in any number of different positions for easy and hands-free use.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system, comprising:
a mounting clamp having a pair of clamp arms that are joined together by a central spring;
a cradle having a central body section that is configured to receive a portable electronic device; and
an elongated shaft having a first end that is secured to the mounting clamp, and a second end that is secured to the cradle.

2. The system of claim 1, wherein the cradle includes a pair of clamping arms that extend outward from the central body section.

3. The system of claim 2, wherein the clamping arms are configured to extend and retract relative to the central body section.

4. The system of claim 2, wherein the cradle is pivotally connected to the elongated shaft.

5. The system of claim 1, further comprising:
padding that is positioned along an inside surface of each of the pair of clamp arms.

6. The system of claim 1, wherein the elongated shaft is flexible.

7. The system of claim 6, wherein the elongated shaft is constructed from a hollow tubular material.
